(19) United States
(12) Patent Application Publication
(10) Pub. No.: US 2018/0284539 A1
(43) Pub. Date: Oct. 4, 2018

(54) TRANSFLECTIVE LCD

(71) Applicant: Wuhan China Star Optoelectronics Technology Co., Ltd., Wuhan City, (CN)

(72) Inventor: Guowei Zha, Wuhan City (CN)

(21) Appl. No.: 15/539,703

(22) PCT Filed: May 16, 2017
(86) PCT No.: PCT/CN2017/084613

§ 371 Date: Jun. 26, 2017

(30) Foreign Application Priority Data
Mar. 31, 2017 (CN) 201710210602.3

(51) Int. Cl. G02F 1/1335; F21V 8/00

(52) U.S. Cl. CPC G02F 1/133555; G02F 2001/133548; G02F 1/133536; G02B 6/0055

(57) ABSTRACT

The invention provides a transflective LCD, comprising: a backlight module, a reflective polarizing layer on the backlight module, an LCD panel on the reflective polarizing layer, and an upper polarizing plate on the LCD panel; the reflective polarizing layer comprising: a plurality of metal reflective plates and metal wire grid polarizing plates, arranged in interleaved manner; the LCD panel comprising a plurality of reflective display areas and transmissive display areas; the reflective display areas corresponding to the metal reflective plates in one-on-one manner; and the transmissive display areas corresponding to the metal wire grid polarizing plates in one-on-one manner; by disposing reflective polarizing layer between the backlight module and LCD panel and disposing the metal reflective plates and metal wire grid polarizing plates inside the reflective polarizing layer simultaneously, the present invention can reduce power consumption, reduce the transflective LCD thickness and reduce manufacturing process difficulty.

### BACKGROUND OF THE INVENTION

### 1. Field of the Invention

The present invention relates to the field of display, and in particular to a transflective liquid crystal display (LCD).

### 2. The Related Arts

As display technology progresses, the liquid crystal display (LCD) shows the advantages of high display quality, low power-consumption, thinness, and wide applications, the LCD is widely used in various devices, such as, liquid crystal TV, mobile phones, PDA, digital camera, PC monitors or notebook PC screens, becomes the leading display technology.

According to the use of different types of light sources, LCD can be divided into transmissive, reflective and transflective; wherein the transmissive type LCD panel mainly uses a backlight as the light source, and the backlight is disposed behind the LCD panel. The light from the backlight module passes through the transparent pixel electrode on the array substrate for displaying images. The transmissive type LCD is suitable for dimly lighted environment, such as indoors. When used outdoors, if the external light is too strong the relative strength of the backlight source will be interfered by the external light, leading to eye fatigue for the viewers and affecting the image quality. Moreover, the long duration use of backlight source consumes much power. As the small size display usually uses battery as power supply, running out of power becomes a constant condition.

The reflective type LCD mainly uses a front light or external light as the light source. The array substrate uses the reflective electrodes made of metal or other material with good reflective characteristics as reflective area to reflect a front light source or other external natural light source to display images. The reflective type LCD is suitable for environments with powerful external light source. Through reflecting natural light, the reflective type LCD can reduce power consumption. However, in dimly lighted environment, the condition of short of light is likely to occur and affects the image quality.

The transflective type LCD can be viewed as a combination of transmissive type and reflective type. The array substrate is disposed with both reflective area and transmissive area, and can use backlight, front light or external natural light as a light source. In dimly lighted environment, the transmissive mode dominates the lighting. That is, the backlight source of the LCD is used to display the images. In a well lighted environment, the reflective mode becomes prominent, that is, using the reflective electrodes inside the LCD panel to reflect the external natural light to display images. Therefore, the transflective type LCD is suitable for various environments, and has the advantages of good outdoor visibility and low power consumption.

The known transflective LCD usually has a smaller transmission area in the display area for energy consideration, and thus relatively low transmittance, resulting in the transmission mode of the transflective LCD consuming more power in backlighting. Moreover, because the optical paths for the reflected light and transmitted light do not coincide, to avoid chromatic aberration, it is also necessary to make a special improvement in the structure of the liquid crystal panel, resulting in a more complicated manufacturing process for transflective LCD than other types of LCD.

### SUMMARY OF THE INVENTION

The object of the present invention is to provide a transflective LCD, able to reduce power consumption, reduce the transflective LCD thickness and reduce manufacturing process difficulty.

To achieve the above object, the present invention provides a transflective liquid crystal display (LCD), comprising: a backlight module, a reflective polarizing layer disposed on the backlight module, an LCD panel disposed on the reflective polarizing layer, and an upper polarizing plate disposed on the LCD panel;

the reflective polarizing layer comprising: a plurality of metal reflective plates and a plurality of metal wire grid polarizing plates, arranged in an interleaved manner;

the LCD panel comprising a plurality of reflective display areas and a plurality of transmissive display areas; the plurality of reflective display areas corresponding to the plurality of metal reflective plates in a one-on-one manner; and the plurality of transmissive display areas corresponding to the plurality of metal wire grid polarizing plates in a one-on-one manner;

the transmission axis of the metal wire grid polarizing plate is perpendicular to or parallel to the transmission axis of the upper polarizing plate.

According to a preferred embodiment of the present invention, the metal wire grid polarizing plate comprises a glass substrate, a dielectric layer covering the glass substrate, and a plurality of parallel spaced-apart metal lines disposed on the dielectric layer.

According to a preferred embodiment of the present invention, a sum of a width of the metal wire and the distance between two adjacent metal lines is 20 to 500 nm, and a ratio of the width of the metal wire to the sum of the width of the metal wire and the distance between two adjacent metal lines is 0.1 to 0.9.

According to a preferred embodiment of the present invention, the metal wire is made of aluminum, silver, or gold, and the dielectric layer is made of a combination of one or more of silicon dioxide, silicon oxide, magnesium oxide, silicon nitride, titanium dioxide, and tantalum pentoxide.

According to a preferred embodiment of the present invention, the LCD panel comprises a first and a second substrates disposed opposite to each other, and a liquid crystal (LC) layer disposed between the first and second substrates.

According to a preferred embodiment of the present invention, the LCD panel is an IPS type, an FFS type, a VA type, a TN type, or an ECB type LCD panel.

According to a preferred embodiment of the present invention, the backlight module comprises a light-emitting source, a light-guiding plate disposed corresponding to the light-emitting source and located below the LCD panel, and a backlight reflection plate disposed on lower side of the light-guiding plate.

According to a preferred embodiment of the present invention, the backlight module is an edge-lit backlight module or a direct-lit backlight module.

According to a preferred embodiment of the present invention, the upper polarizing plate is an absorbing polarizing plate.

The present invention also provides a transflective liquid crystal display (LCD), comprising: a backlight module, a reflective polarizing layer disposed on the backlight module, an LCD panel disposed on the reflective polarizing layer, and an upper polarizing plate disposed on the LCD panel;

the reflective polarizing layer comprising: a plurality of metal reflective plates and a plurality of metal wire grid polarizing plates, arranged in an interleaved manner;

the LCD panel comprising a plurality of reflective display areas and a plurality of transmissive display areas; the plurality of reflective display areas corresponding to the plurality of metal reflective plates in a one-on-one manner; and the plurality of transmissive display areas corresponding to the plurality of metal wire grid polarizing plates in a one-on-one manner;

the transmission axis of the metal wire grid polarizing plate is perpendicular to or parallel to the transmission axis of the upper polarizing plate;

wherein the metal wire grid polarizing plate comprising a glass substrate, a dielectric layer covering the glass substrate, and a plurality of parallel spaced-apart metal lines disposed on the dielectric layer;

the LCD panel comprising a first and a second substrates disposed opposite to each other, and a liquid crystal (LC) layer disposed between the first and second substrates.

Compared to the known techniques, the present invention provides the following advantages: the present invention provides a transflective LCD, comprising a backlight module, a reflective polarizing layer disposed on the backlight module, an LCD panel disposed on the reflective polarizing layer, and an upper polarizing plate disposed on the LCD panel; the reflective polarizing layer comprising: a plurality of metal reflective plates and a plurality of metal wire grid polarizing plates, arranged in an interleaved manner; the LCD panel comprising a plurality of reflective display areas and a plurality of transmissive display areas; the plurality of reflective display areas corresponding to the plurality of metal reflective plates in a one-on-one manner; and the plurality of transmissive display areas corresponding to the plurality of metal wire grid polarizing plates in a one-on-one manner; by disposing reflective polarizing layer between the backlight module and LCD panel and disposing the metal reflective plates and metal wire grid polarizing plates inside the reflective polarizing layer simultaneously, the present invention can reduce power consumption, reduce the transflective LCD thickness and reduce manufacturing process difficulty.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIG. 1 is a schematic view showing the structure of a transflective LCD according to the present invention;

FIG. 2 is a schematic view showing the structure of a metal wire grid polarizing plate of the transflective LCD according to the present invention;

FIG. 3 is a schematic view showing the structure of a reflective polarizing layer of the transflective LCD according to the present invention;

FIG. 4 is a schematic view showing the optical path of transmissive display area of the transflective LCD realizing plain black and plain white displaying according to the present invention;

FIG. 5 is a schematic view showing the optical path of reflective display area of the transflective LCD realizing plain black and plain white displaying according to the present invention;

FIG. 6 is a schematic view showing the optical path of the transflective LCD in transmissive mode according to the present invention.

### DETAILED DESCRIPTION OF THE PREFERRED EMBODIMENTS

To further explain the technical means and effect of the present invention, the following refers to embodiments and drawings for detailed description.

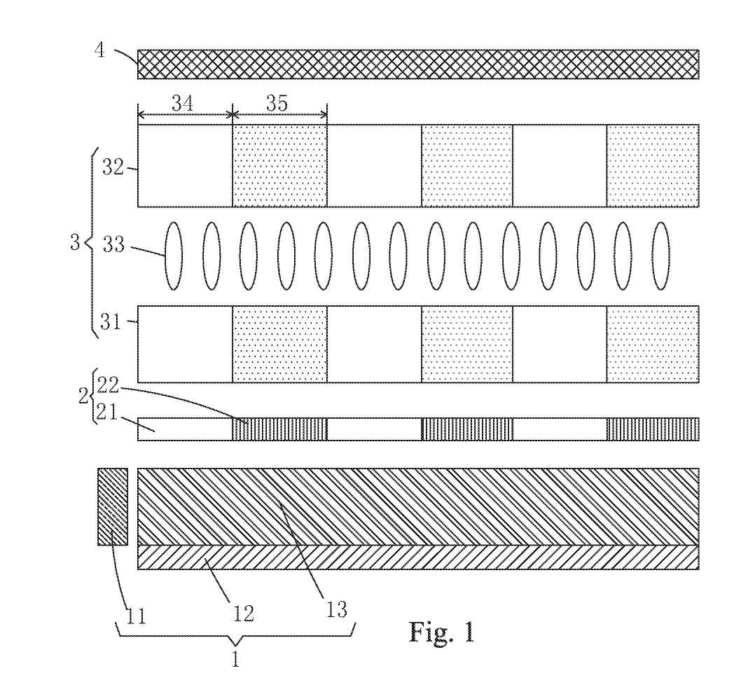

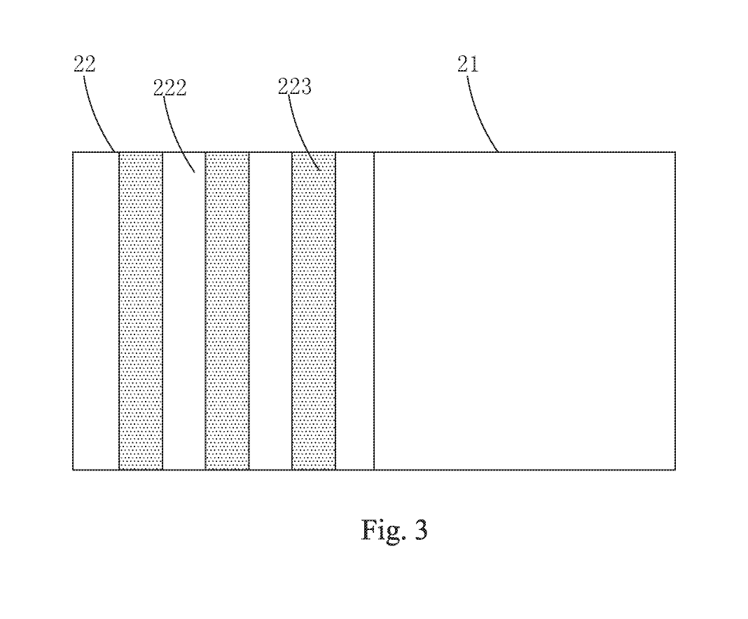

Refer to FIG. 1 and FIG. 3. The present invention provides a transflective liquid crystal display (LCD), comprising: a backlight module 1, a reflective polarizing layer 2 disposed on the backlight module 1, an LCD panel 3 disposed on the reflective polarizing layer 2, and an upper polarizing plate 4 disposed on the LCD panel 3;

the reflective polarizing layer 2 comprising: a plurality of metal reflective plates 21 and a plurality of metal wire grid polarizing plates 22, arranged in an interleaved manner; the LCD panel 3 comprising a plurality of reflective display areas 34 and a plurality of transmissive display areas 35; the plurality of reflective display areas 34 corresponding to the plurality of metal reflective plates 21 in a one-on-one manner; and the plurality of transmissive display areas 35 corresponding to the plurality of metal wire grid polarizing plates 22 in a one-on-one manner;

the transmission axis of the metal wire grid polarizing plate 22 is perpendicular to or parallel to the transmission axis of the upper polarizing plate 4.

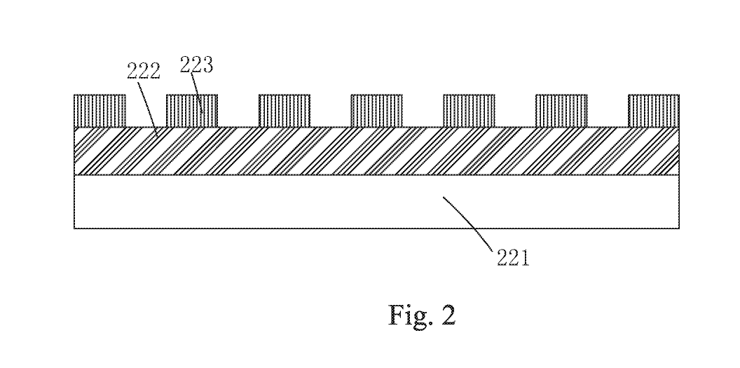

Specifically, refer to FIG. 2 and FIG. 3. The metal wire grid polarizing plate 22 comprises a glass substrate 221, a dielectric layer 222 covering the glass substrate 221, and a plurality of parallel spaced-apart metal lines 223 disposed on the dielectric layer 222.

Preferably, a sum of a width of the metal wire 223 and the distance between two adjacent metal lines 223 is 20 to 500 nm, and a ratio of the width of the metal wire 223 to the sum of the width of the metal wire 223 and the distance between two adjacent metal lines 223 is 0.1 to 0.9.

Preferably, the metal wire 223 is made of aluminum, silver, or gold, and the dielectric layer 222 is made of a combination of one or more of silicon dioxide, silicon oxide, magnesium oxide, silicon nitride, titanium dioxide, and tantalum pentoxide.

Specifically, the LCD panel 3 comprises a first and a second substrates 31, 32 disposed opposite to each other, and a liquid crystal (LC) layer 33 disposed between the first and second substrates 31, 32.

Specifically, the LCD panel 3 of the present invention is not restricted to any specific type, and the LCD panel 3 can be an In-Plane Switching (IPS) type, a Fringe Field Switching (FFS) type, a Vertical Alignment (VA) type, a Twisted Nematic (TN) type, or an Electrically Controlled Birefringence (ECB) type LCD panel.

Specifically, the backlight module 1 comprises: a light-emitting source 11, a light-guiding plate 13 disposed corresponding to the light-emitting source 11 and located below the LCD panel 3, and a backlight reflection plate 12 disposed on lower side of the light-guiding plate 13. Preferably, the light-emitting source is a light-emitting diode (LED).

Moreover, the backlight module 1 of the present invention is not restricted to any specific type, and the backlight module 1 can be an edge-lit backlight module or a direct-lit backlight module.

Preferably, the upper polarizing plate 4 is an absorbing polarizing plate.

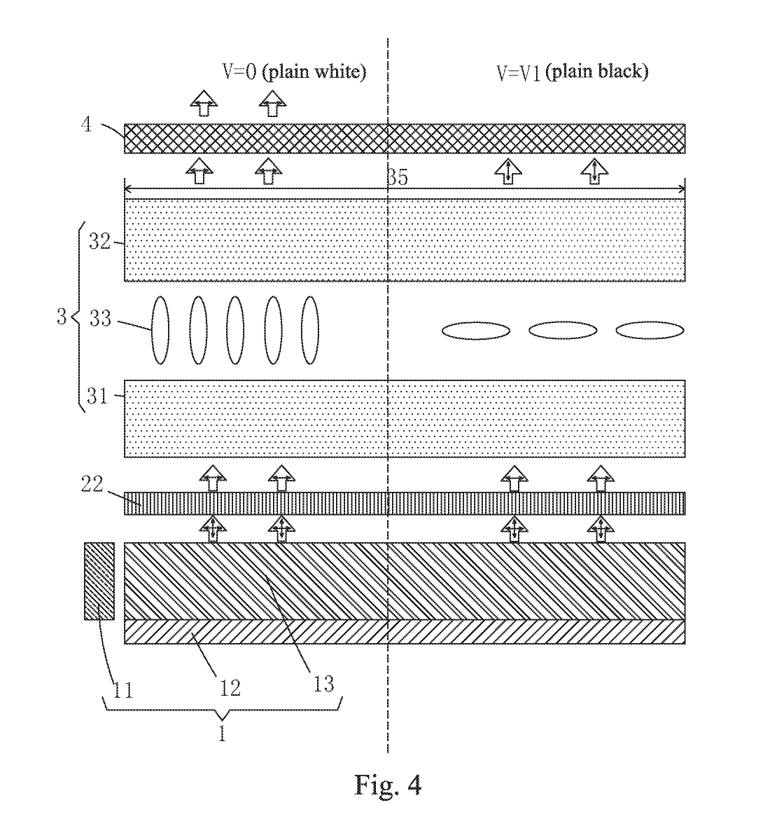

The present invention will now be further described with reference to the preferred embodiments of the present invention. In the preferred embodiment, the transmission axis of the metal wire grid polarizing plate 22 is parallel to the transmission axis of the upper polarizing plate 4 so that the display mode of the transmissive display area 35 can realize plain white or plain black displays, as shown in FIG. 4. FIG. 4 shows the bias voltage V on the LCD panel 3 is equal to 0 when the transmissive display area 35 is displaying the plain white display. The LC molecules do not flip, and the light emitted from the backlight module 1 passes through the metal wire grid polarizing plate 22 to form linearly polarized light parallel to the transmission axis of the metal wire grid polarizing plate 22, which passes through the non-flipped LC layer 33 and maintains parallel to the transmission axis of the metal wire grid polarizing plate 22. The transmission axis of the metal wire grid polarizing plate 22 is parallel to the transmission axis of the upper polarizing plate 4, and the linearly polarized light is emitted from the upper polarized plate 4 to realize the plain white display. The bias voltage V on the LCD panel 3 is equal to a first voltage V1 when the transmissive display area 35 is displaying the plain black display. The LC molecules are flipped, and the phase delay of the LC layer 33 is equal to a half-wave plate. The light emitted from the backlight module 1 passes through the metal wire grid polarizing plate 22 to form a linearly polarized light parallel to the transmission axis of the metal wire grid polarizing plate 22, which passes through the flipped LC layer 33 and maintains perpendicular to the transmission axis of the metal wire grid polarizing plate 22. The transmission axis of the metal wire grid polarizing plate 22 is parallel to the transmission axis of the upper polarizing plate 4, and the linearly polarized light cannot be emitted from the upper polarized plate 4, thus, to realize the plain black display.

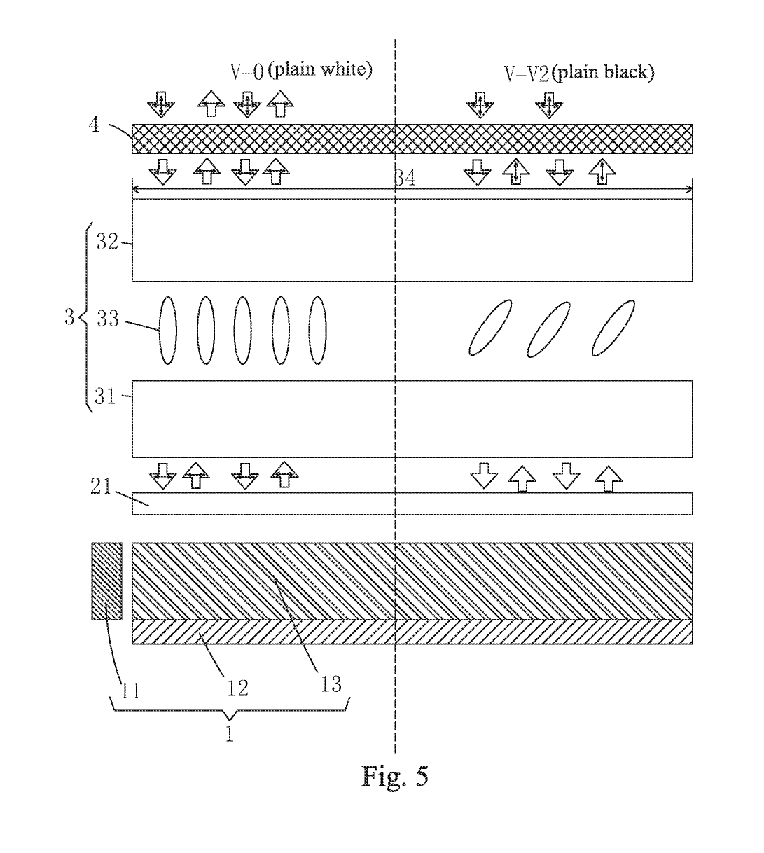

Refer to FIG. 5. The bias voltage V on the LCD panel 3 is equal to 0 when the reflective display area 34 is displaying the plain white display. The external natural light passes through the upper polarizing plate 4 to form a linearly polarized light parallel to the transmission axis of the upper polarizing plate 4, and then passes through the LC layer 33, the metal reflective plate 21, and the LC layer 33 to maintain as a linearly polarized light parallel to the transmission axis of the upper polarizing plate 4, which can be emitted again through the upper polarizing plate 4 to realize a plain white display. The bias voltage V on the LCD panel 3 is equal to a second voltage V2 when the reflective display area 34 is displaying the plain black display. The LC molecules are flipped and the phase delay of the LC layer 33 is a quarter-wave plate. The external natural light passes through the upper polarizing plate 4 to form a linearly polarized light parallel to the transmission axis of the upper polarizing plate 4, and then passes through the LC layer 33, the metal reflective plate 21, and the LC layer 33 to form a linearly polarized light perpendicular to the transmission axis of the upper polarizing plate 4, which cannot be emitted again through the upper polarizing plate 4, and thus realize a plain black display.

It should be noted that the present invention can also select the transmission axis of the metal wire grid polarizing plate 22 to be perpendicular to the transmission axis of the upper polarizing plate 4, which can also realize plain white and plain black displays in the transmissive display area 35 and the reflective display area 34. The bias voltage applied to the LCD panel 3 at the time of the plain black display is 0, and the bias voltage applied to the LCD panel 3 is always the first voltage V1 and the second voltage V2, respectively, for plain white display.

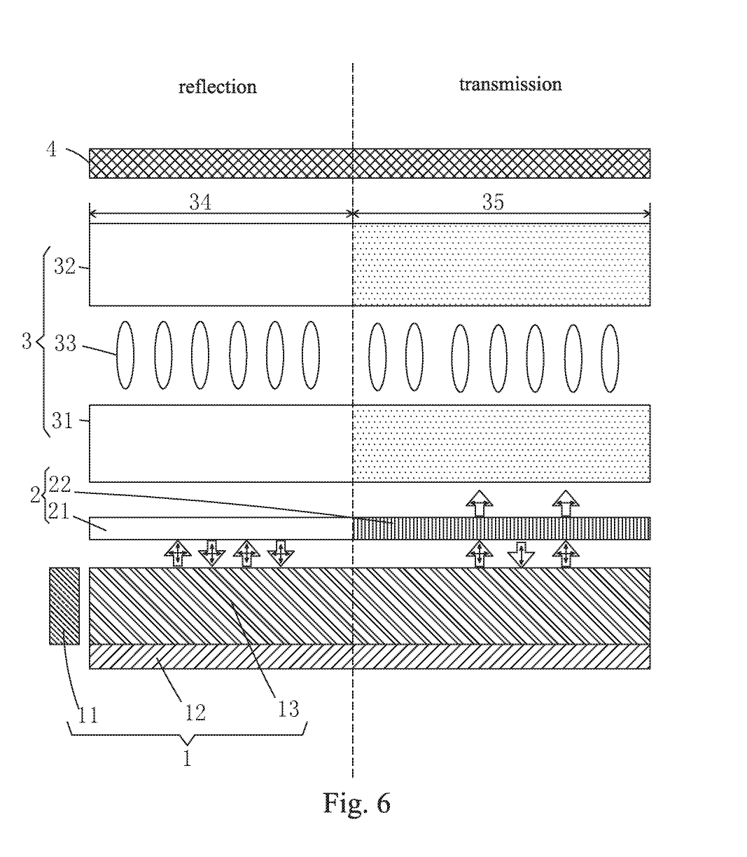

Refer to FIG. 6. During the transflective LCD operating in the transmissive mode, when the light emitted from the backlight module 1 arrives at the reflective polarizing layer 2, the light at the reflective display area 34 is reflected back by the metal reflective plate 21 and re-enters the light-guiding plate 13 for re-use; the linearly polarized light having a polarization direction perpendicular to the transmission axis of the metal wire grid polarizing plate 22 at the reflective display area 35 is reflected and re-enters the light-guiding plate 13 for re-use, and the linearly polarized light with polarization direction parallel to the transmission axis of the metal wire grid polarizing plate 22 passes through the metal wire grid polarizing plate 22 to emit into the LCD panel 3, thereby improving the backlight utilization efficiency to a maximum extent and saving power.

Moreover, compared to the known technology, the present invention does not need to change the structure of the LCD panel 3. In other words, the known structure of using LC layer sandwiched between an upper and a lower substrates cab be used to realize the transflective display, leading to reducing the LCD thickness and process difficulty.

In summary, the present invention provides a transflective LCD, comprising: a backlight module, a reflective polarizing layer disposed on the backlight module, an LCD panel disposed on the reflective polarizing layer, and an upper polarizing plate disposed on the LCD panel; the reflective polarizing layer comprising: a plurality of metal reflective plates and a plurality of metal wire grid polarizing plates, arranged in an interleaved manner; the LCD panel comprising a plurality of reflective display areas and a plurality of transmissive display areas; the plurality of reflective display areas corresponding to the plurality of metal reflective plates in a one-on-one manner; and the plurality of transmissive display areas corresponding to the plurality of metal wire grid polarizing plates in a one-on-one manner; by disposing reflective polarizing layer between the backlight module and LCD panel and disposing the metal reflective plates and metal wire grid polarizing plates inside the reflective polarizing layer simultaneously, the present invention can reduce power consumption, reduce the transflective LCD thickness and reduce manufacturing process difficulty.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

What is claimed is:

1. A transflective liquid crystal display (LCD), comprising: a backlight module, a reflective polarizing layer disposed on the backlight module, an LCD panel disposed on the reflective polarizing layer, and an upper polarizing plate disposed on the LCD panel;
the reflective polarizing layer comprising: a plurality of metal reflective plates and a plurality of metal wire grid polarizing plates, arranged in an interleaved manner;
the LCD panel comprising a plurality of reflective display areas and a plurality of transmissive display areas; the plurality of reflective display areas corresponding to the plurality of metal reflective plates in a one-on-one manner; and the plurality of transmissive display areas corresponding to the plurality of metal wire grid polarizing plates in a one-on-one manner;
the transmission axis of the metal wire grid polarizing plate is perpendicular to or parallel to the transmission axis of the upper polarizing plate.

2. The transflective LCD as claimed in claim 1, wherein the metal wire grid polarizing plate comprises a glass substrate, a dielectric layer covering the glass substrate, and a plurality of parallel spaced-apart metal lines disposed on the dielectric layer.

3. The transflective LCD as claimed in claim 2, wherein a sum of a width of the metal wire and the distance between two adjacent metal lines is 20 to 500 nm, and a ratio of the width of the metal wire to the sum of the width of the metal wire and the distance between two adjacent metal lines is 0.1 to 0.9.

4. The transflective LCD as claimed in claim 2, wherein the metal wire is made of aluminum, silver, or gold, and the dielectric layer is made of a combination of one or more of silicon dioxide, silicon oxide, magnesium oxide, silicon nitride, titanium dioxide, and tantalum pentoxide.

5. The transflective LCD as claimed in claim 1, wherein he LCD panel comprises a first and a second substrates disposed opposite to each other, and a liquid crystal (LC) layer disposed between the first and second substrates.

6. The transflective LCD as claimed in claim 1, wherein the LCD panel is an IPS type, an FFS type, a VA type, a TN type, or an ECB type LCD panel.

7. The transflective LCD as claimed in claim 1, wherein the backlight module comprises a light-emitting source, a light-guiding plate disposed corresponding to the light-emitting source and located below the LCD panel, and a backlight reflection plate disposed on lower side of the light-guiding plate.

8. The transflective LCD as claimed in claim 1, wherein the backlight module is an edge-lit backlight module or a direct-lit backlight module.

9. The transflective LCD as claimed in claim 1, wherein the upper polarizing plate is an absorbing polarizing plate.

10. A transflective liquid crystal display (LCD), comprising: a backlight module, a reflective polarizing layer disposed on the backlight module, an LCD panel disposed on the reflective polarizing layer, and an upper polarizing plate disposed on the LCD panel;
the reflective polarizing layer comprising: a plurality of metal reflective plates and a plurality of metal wire grid polarizing plates, arranged in an interleaved manner;
the LCD panel comprising a plurality of reflective display areas and a plurality of transmissive display areas; the plurality of reflective display areas corresponding to the plurality of metal reflective plates in a one-on-one manner; and the plurality of transmissive display areas corresponding to the plurality of metal wire grid polarizing plates in a one-on-one manner;
the transmission axis of the metal wire grid polarizing plate is perpendicular to or parallel to the transmission axis of the upper polarizing plate;
wherein the metal wire grid polarizing plate comprising a glass substrate, a dielectric layer covering the glass substrate, and a plurality of parallel spaced-apart metal lines disposed on the dielectric layer;
wherein he LCD panel comprising a first and a second substrates disposed opposite to each other, and a liquid crystal (LC) layer disposed between the first and second substrates.

11. The transflective LCD as claimed in claim 10, wherein a sum of a width of the metal wire and the distance between two adjacent metal lines is 20 to 500 nm, and a ratio of the width of the metal wire to the sum of the width of the metal wire and the distance between two adjacent metal lines is 0.1 to 0.9.

12. The transflective LCD as claimed in claim 10, wherein the metal wire is made of aluminum, silver, or gold, and the dielectric layer is made of a combination of one or more of silicon dioxide, silicon oxide, magnesium oxide, silicon nitride, titanium dioxide, and tantalum pentoxide.

13. The transflective LCD as claimed in claim 10, wherein the LCD panel is an IPS type, an FFS type, a VA type, a TN type, or an ECB type LCD panel.

14. The transflective LCD as claimed in claim 10, wherein the backlight module comprises a light-emitting source, a light-guiding plate disposed corresponding to the light-emitting source and located below the LCD panel, and a backlight reflection plate disposed on lower side of the light-guiding plate.

15. The transflective LCD as claimed in claim 10, wherein the backlight module is an edge-lit backlight module or a direct-lit backlight module.

16. The transflective LCD as claimed in claim 10, wherein the upper polarizing plate is an absorbing polarizing plate.
